(19) United States
(12) Patent Application Publication
(10) Pub. No.: US 2010/0107572 A1
(43) Pub. Date: May 6, 2010

(54) Packaging Machine with at Least One Pneumatic Drive

(75) Inventors: Tieme Jan Slomp, Bad Groenenbach (DE); Elmar Eugen Ehrmann, Bad Groenenbach (DE); Herbert Kirmse, Wolfertschwenden (DE)

Correspondence Address: BROOKS KUSHMAN P.C., 1000 TOWN CENTER, TWENTY-SECOND FLOOR, SOUTHFIELD, MI, 48075, US

(73) Assignee: MULTIVAC, Wolfertschwenden (DE)

(21) Appl. No.: 11/990,183

(22) PCT Filed: Jul. 18, 2006
(86) PCT No.: PCT/DE2006/001251

§ 371 Date: Jul. 15, 2008

(30) Foreign Application Priority Data
Aug. 11, 2005 (DE) 10 2005 038 357.2

(51) Int. Cl. B65B 9/04; B65B 65/00; F15B 15/20

(52) U.S. Cl. 53/559; 53/393; 91/304; 91/418

(57) ABSTRACT

A packaging machine with at least one pneumatic drive is proposed, which packaging machine is insensitive to dirt and is easy to clean. According to the invention, this is achieved by provision of an integrated structural unit (8, 9, 10) which comprises a pilot valve and a pneumatic cylinder.

The invention relates to a packaging machine with at least one pneumatic drive in accordance with the precharacterizing clause of claim 1.

In packaging machines, in particular tray-sealing machines or so-called deep-drawing machines, in which trays formed from foils are sealed and cut out, pneumatic drives are used in various working stations.

Thus, for example, pneumatic cylinders are used as the drive for the lifting units in shaping stations, sealing stations and/or cutting stations, which pneumatic cylinders are operated via an electrically driveable pilot valve. The pilot valves for these pneumatic cylinders are generally accommodated in the region of the switchgear cabinet, in a separate pneumatic cabinet or so-called valve islands on the machine frame. In all of these cases, it is necessary to lay a separate pneumatic line from the pilot valve to the pneumatic cylinder for each cylinder movement.

In particular in the sector of food packaging, stringent requirements are placed on hygiene. It is therefore necessary for such a machine, if possible, to be not very susceptible to dirt and to be easy to clean.

The object of the invention is therefore to propose a packaging machine which is insensitive to dirt and which is easier to clean.

This object is achieved, on the basis of a packaging machine of the type mentioned in the introductory part, by the characterizing features of claim 1.

Owing to the measures mentioned in the dependent claims, advantageous embodiments and developments of the invention are possible.

Correspondingly, a packaging machine according to the invention is characterized by the fact that the pilot valve and the pneumatic cylinder are combined to form an integrated unit. This simplifies the routing of the pneumatic lines in the machine. A pneumatic line can be passed to the pilot valve, which for its part controls all the movements of the pneumatic cylinder. A reduction in the number and/or length of the lines at the same time means a reduction in the potential dirt catches on the machine and therefore an improvement in the cleaning possibilities, which complies with the need for cleanliness and in particular hygiene of the machine. Furthermore, fitting and maintenance of the machine are simplified.

Preferably, this integrated unit comprising the pilot valve and the pneumatic cylinder is configured without any external connecting line between the pilot valve and the pneumatic cylinder, as a result of which the abovementioned advantages as regards reduced sensitivity to dirt and improved cleaning possibility are further improved.

Furthermore, an integrated unit according to the invention is preferably also provided with sensors, for example with displacement measurement systems, proximity sensors and/or limit switches. Such sensors until now have been fitted separately on the machine or externally on the pneumatic cylinder and therefore, also need to be provided separately with signal and supply lines. Both the sensors and the associated lines represent potential dirt catches. Owing to the integrated in the unit according to the invention, the number of electrical lines is now reduced. Furthermore, the sensors can be arranged in such a way that no external dirt catches or the like are created by them. The advantages to be achieved with the invention are hereby further increased.

In a simple embodiment of the invention, the exhaust air from the pneumatic cylinder is dissipated into the surrounding environment. Depending on the application case, however, it is possible for the exhaust air to be guided. In this case, in one development of the invention, the routing for the inlet air and exhaust air is combined in a double pneumatic line. One possibility here is, for example, a double-walled flexible tube, which supplies the compressed air in the interior and guides the decompressed exhaust air away in the intermediate space of the double-walled flexible tube.

In a particular embodiment of the invention, the electrical lines and the pneumatic lines are combined in a common routing system in order to further increase the advantages according to the invention.

This can take place, for example, by virtue of the fact that the pneumatic line is implemented in a multiple line, into which the required electrical lines are inserted. In the case of the exemplary embodiment given above with an exhaust air feed to the surrounding environment, this can likewise be realized, for example, with the aid of a double flexible tube. A multiple flexible tube with more than two line channels could also be realized, for example, by virtue of the fact that a plurality of flexible tubes are arranged along the circumference around a central pneumatic flexible tube, which is provided, for example, for the supply of compressed air, and are held together by a sheath to form one unit.

Preferably, in the case of a packaging machine according to the invention, a pneumatic ring line is provided. As a result, a plurality of integrated pneumatic units according to the invention can be supplied with compressed air by one line. The complexity involved in terms of lines during fitting and maintenance is therefore reduced. Furthermore, the total line length provided is further reduced in a packaging machine with such a design, which results in a further increase in the advantages according to the invention.

The electrical routing is also preferably realized in the form of a ring line in order to connect a plurality of pneumatic units according to the invention. In an electrical ring line, the same advantages result as in the case of the pneumatic ring line mentioned above, in a particularly advantageous and further improved embodiment the electrical ring line and the pneumatic ring line being capable of being combined so as to form a common ring line.

In order to realize an electrical ring line for a plurality of pneumatic units according to the invention, a multipole line is preferably used. In a simple embodiment, in this case separate wires are guided in the multipole line for each pneumatic unit and are branched off from the multipole line at the corresponding use point.

In an advantageous development of the invention, the pneumatic units according to the invention are provided with a bus interface, so that both the supply line or lines and the signal line or lines can be used jointly for the different pneumatic units.

In a development of the bus-compatible embodiment, a wireless bus is provided so that the integrated pneumatic units now only need to be provided with a pneumatic connection and an electrical energy supply.

In particular application cases, a pneumatic unit which has been integrated according to the invention, in particular in conjunction with a wireless bus, can be equipped with a dedicated electrical energy supply, for example a battery or a generator. Such a generator can be operated, for example pneumatically or mechanically, via the compressed air supply or the movement of the pneumatic cylinder, so that, in conjunction with a wireless bus, only the pneumatic connection is now required.

Another development of the invention provides a pilot valve in a pneumatic unit according to the invention, which pilot valve is suitable for controlling a plurality of pneumatic cylinders and/or pneumatic motors. If these additional pneumatic cylinders and motors are required at the same use location, they can also be integrated easily in the pneumatic unit according to the invention.

A pneumatic unit according to the invention can be accommodated, for example, in a common housing for the pneumatic cylinder and the pilot valve. This results in a smooth surface which can be cleaned easily.

Another embodiment which is easy to clean consists in the components being joined to one another to form a complete unit, attention preferably being paid to surfaces terminating flush.

Advantageously, a cleaning setting is provided for the lifting units provided in the packaging machine. Such a cleaning setting serves the purpose of bringing machine components into a position, for example closing the form tools, in which position they are not impaired by any cleaning media.

The cleaning setting is preferably assumed when the machine is switched off. For this purpose, a locking unit is preferably provided, which locks the lifting units in the unpressurized state. This can be carried out, for example, by mechanical locking of the end position of the pneumatic units, which is actuated by a control routine integrated in the machine controller. A lock which can be actuated via a spring-loaded piston or an electromechanical unit which locks the end position of the pneumatic unit are possible examples. Unpressurized locking provides the advantage that no separate additional flexible tube is required for driving the locking. In the event of a spring-loaded locking unit, the spring force acts as the drive for the locking, and in the case of an electromechanical locking unit, the latter can be driven via a multipole cable which is provided in any case.

An exemplary embodiment of the invention is described in the drawing and will be explained in more detail below with reference to the figures, in which, specifically:

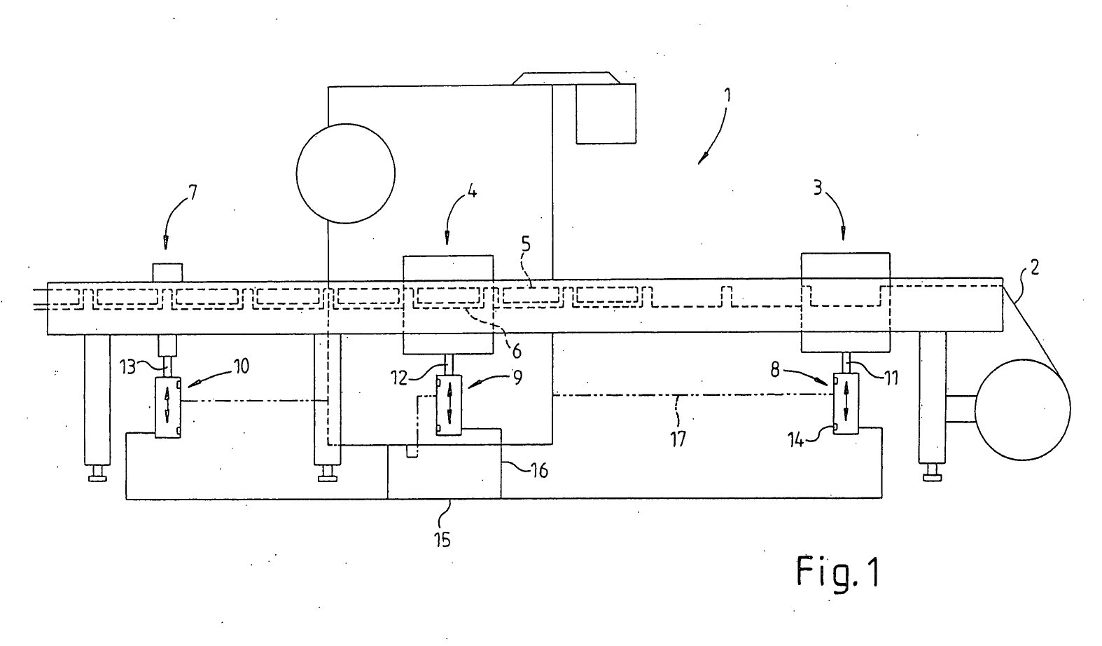

FIG. 1 shows a schematic illustration of a packaging machine in a side view, and

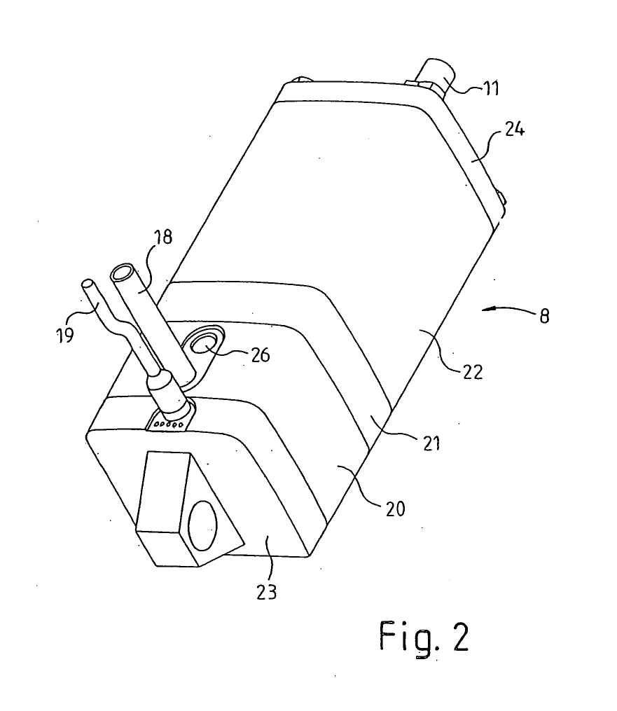

FIG. 2 shows a schematic, perspective illustration of a pneumatic unit according to the invention.

FIG. 1 shows a packaging machine 1 in the form of a so-called deep-drawing machine. A packaging foil 2 is deep-drawn in a forming station 3 so as to form a depression for accommodating goods to be packaged. In a sealing station 4, a cover foil is applied to the packaging 6 which has been filled with the goods to be packaged 5. In a subsequent cutting station 7, the still cohesive packagings are cut away from one another.

Pneumatic units 8, 9, 10 according to the invention, which comprise a pneumatic cylinder and a pilot valve in a manner not illustrated in any more detail, are arranged both in the forming station and in the sealing station and the cutting station. The pneumatic units 8, 9, 10 act, via the piston rods 11, 12, 13, as a lifting unit in the respective machining station 3, 4, 7. The lifting movement is in each case indicated by double arrows.

In this case, the lifting movement does not need to be transferred to the machine component to be lifted directly via the piston rod of the lifting unit. Depending on the application case, in this case gear mechanisms, for example toggle levers, multiple-bar linkages or the like can be interposed in order to reinforce the lifting force in order to bring about guidance for the movement or in order to form a plurality of points at which the lifting force acts on the component to be lifted, for example a mold of the forming station 3.

Furthermore, the pneumatic units 8, 9, 10 comprise sensors 14 (illustrated schematically) for detecting the end position.

As can easily be seen in FIG. 1, it is possible owing to the integrated design of the pneumatic units 8, 9, 10 for the pneumatic unit 8, 9, 10, starting from a ring line 15, possibly via a stub line 16, to be supplied with the required compressed air. Owing to the integrated design, only one pneumatic connection for each pneumatic unit 8, 9, 10 is required.

Likewise, in each case only one electrical line is required for each pneumatic unit 8, 9, 10, which electrical line in the form of a multipole cable contains both the energy supply and the signal line for the pilot valve and for the sensors 14.

It can be seen from FIG. 1 that, owing to the integrated design of the pneumatic units 8, 9, 10, the number of lines and therefore also the total line length required is considerably reduced. This results in the advantages according to the invention as regards the sensitivity to dirt and the ease of cleaning. Furthermore, fitting and construction of the packaging machine 1 is hereby simplified.

FIG. 2 shows a pneumatic unit 8, which, as mentioned above, only has two connections, a pneumatic connection 18 and an electrical connection 19. The entire pneumatic unit 8 comprises individual assembled segments 20, 21, 22, which contain the pilot valve, the pneumatic cylinders and the connections between these two components. It can easily be seen from FIG. 2 that these segments can be joined together in an interlocking manner with a flush surface so that overall a smooth surface which is easy to clean results. The mechanical connection is produced on the cylinder side via the end flange 23, while the piston rod 11 passes through the end flange 24.

Furthermore, light-emitting diodes 25 and an exhaust air opening 26 are also provided which do not, however, impair the advantageous configuration of the lifting units with a surface which is smooth, flush and therefore easy to clean. The light-emitting diodes are used for indicating operating states of the pneumatic unit 8, for example the valve switching position or the end position.

In addition to the embodiment illustrated, other configurations of the invention are also possible. The integrated design of a pneumatic unit 8 including a pneumatic cylinder and the associated pilot valve is essential for achieving the above-described advantages.

### LIST OF REFERENCE SYMBOLS

1 Packaging machine
2 Packaging foil
3 Forming station
4 Sealing station
5 Goods to be packaged
6 Packaging
7 Cutting station
8 Pneumatic unit
9 Pneumatic unit
10 Pneumatic unit
11 Piston rod
12 Piston rod
13 Piston rod
14 Sensors
15 Ring line
16 Stub line
17 Electrical line
18 Pneumatic connection
19 Electrical connection
20 Segment
21 Segment
22 Segment
23 End flange
24 End flange
25 Light-emitting diodes
26 Exhaust air opening

1. A packaging machine comprising:
at least one pneumatic drive, which comprises a pneumatic cylinder and an electrically controllable pilot valve for controlling the pneumatic cylinder, wherein the pilot valve and the pneumatic cylinder are in the form of an integrated unit.

2. The packaging machine as claimed in claim 1, wherein the integrated unit has an internal connecting line between the pilot valve and the pneumatic cylinder.

3. The packaging machine as claimed in one of the preceding claims, wherein the integrated unit comprises an integrated sensor.

4. The packaging machine as claimed in claim 3, wherein the sensor comprises a displacement measurement system, a proximity sensor and/or a limit switch.

5. The packaging machine as claimed in claim 1, further comprising a pneumatic line connected to the integrated unit, wherein the pneumatic line comprises at least two compressed air channels.

6. The packaging machine as claimed in claim 1, further comprising an electrical line and a pneumatic line connected to the integrated unit, wherein the electrical line and the pneumatic line are combined to form a multiple line.

7. The packaging machine as claimed in claim 1, further comprising a pneumatic ring line connected to the integrated unit.

8. The packaging machine as claimed in claim 1, further comprising an electric ring line in communication with the integrated unit.

9. The packaging machine as claimed in claim 1, further comprising a multi-pole electrical line connected to the integrated unit.

10. The packaging machine as claimed in claim 1, wherein the integrated unit comprises an interface for an electronic data bus.

11. The packaging machine as claimed in claim 1, further comprising a wireless data bus in communication with the integrated unit.

12. The packaging machine as claimed in claim 1, wherein the integrated unit comprises a common housing for the pneumatic cylinder and the pilot valve.

13. The packaging machine as claimed in claim 1, wherein the pneumatic cylinder and the pilot valve are joined to one another so as to form the integrated unit.

14. The packaging machine as claimed in claim 1, wherein the integrated unit comprises segments, which are joined to one another, with flush surfaces.

15. A packaging machine comprising:
a working station; and
an integrated pneumatic drive unit associated with the working station, the integrated pneumatic drive unit including a pneumatic cylinder, an electrically controllable pilot valve connected to the pneumatic cylinder for controlling operation of the pneumatic cylinder, and a housing associated with the pneumatic cylinder and the pilot valve.

16. The packaging machine of claim 15 wherein the housing comprises multiple segments.

17. The packaging machine of claim 15 wherein the integrated pneumatic drive unit comprise an internal connecting line extending between the pilot valve and the pneumatic cylinder.
